(19) United States
(12) Patent Application Publication
(10) Pub. No.: US 2017/0332800 A1
(43) Pub. Date: Nov. 23, 2017

(54) ELECTRIC MOTOR DUAL DRIVE

(71) Applicant: de Werth Group AG, Zurich (CH)

(72) Inventor: Eckhart DEWERT, Goldingen (CH)

(21) Appl. No.: 15/582,730

(22) Filed: Apr. 30, 2017

(30) Foreign Application Priority Data
Apr. 29, 2016 (DE) 10 2016 108 033.0
Jul. 28, 2016 (DE) 10 2016 113 980.7
Aug. 31, 2016 (DE) 10 2016 116 256.6

(51) Int. Cl. A47C 20/04; A61G 7/018; A47C 17/175; A47C 20/10; A47C 19/00; A61G 7/015

(52) U.S. Cl. CPC A47C 20/041; A61G 7/018; A47C 17/1756; A47C 19/005; A61G 7/015; A47C 20/10

(57) ABSTRACT

An electric motor drive unit for adjusting supporting parts, articulatedly mounted relative to one another, of a support device to support a box spring mattress or an upholstered bed relative to each other. It includes a base, on which two drive units are arranged. Each drive unit includes an output member, and each interacts with a pivot lever in the installation position of the dual drive. The dual drive is disposed in an operative connection with an adjustable supporting part to pivot the same. The pivot levers are attached articulatedly mounted to the base such that the base together with the pivot levers form a unit attachable to a support device.

### CROSS-REFERENCE TO RELATED APPLICATIONS

This application claims the priority of German application no. DE 10 2016 108 033.0, filed Apr. 29, 2016, German application no. DE 10 2016 113 980.7, filed Jul. 28, 2016, and DE 10 2016 116 256.6, filed Aug. 31, 2016, and each of which is incorporated herein by reference.

### FIELD OF THE INVENTION

The invention relates to an electric motor dual drive for adjusting supporting parts which are pivot-mounted relative to one another of a support device to support a mattress.

### BACKGROUND OF THE INVENTION

Such dual drives are generally known. They comprise a base unit being formed as a casing, in which two drive units are arranged, each comprising an output member that interacts in the installation position of the dual drive with a pivot element in the form of a pivot shaft, which is disposed in an operative connection with an adjustable supporting part to pivot the same supporting part. The pivot shaft is part of an adjustment fitting being part of an adjustable support device, for example of a slatted frame. The output member is generally formed by a linear moving spindle nut in the known furniture drives. To implement the linear movement of the spindle nut in a pivoting movement of the pivot shaft, a link lever is non-rotatably fitted to the pivot shaft. To adjust a supporting part of the support device, the spindle nut presses against the link lever such that the pivot shaft pivots and the supporting part is thereby shifted in the desired manner.

### OBJECTS AND SUMMARY OF THE INVENTION

An object of the invention is to improve a relevant dual drive in view of adjusting a box spring mattress.

This object is achieved by the invention set forth herein.

The invention provides that the pivot levers are attached pivot-mounted to the base unit such that the base unit together with the pivot levers forms a unit being attachable to a support device.

In this way, a separate adjustment fitting is unnecessary such that a box spring mattress can also be designed to be electric motor adjustable in a particularly simple way with a dual drive according to the invention.

An advantageous further embodiment of the invention provides that the or each output member is linear moving. Relevant linear drives are relatively cost-effective and also suitable for applying great forces or torques.

A further embodiment of the above embodiment provides that the output member is a spindle nut, which is arranged non-rotatably and moveable in the axial direction on a fixed threaded spindle, disposed in a rotary drive connection with an electric motor of the drive unit.

Another further embodiment of the invention provides that the output member is a spindle nut, which is mounted non-rotatably and moveable in the axial direction and on which a fixed threaded spindle is arranged, which is disposed in a rotary drive connection with an electric motor of the drive unit.

With the aforementioned embodiments, a spindle drive is arranged in the drive train of the drive unit. Appropriate spindle drives are available as relatively simple and cost-effective standard components and are suitable for applying great forces or torques.

An operative connection between the pivot lever and the output member of the drive unit can be manufactured in any suitable way according to the relevant requirements. In this respect, a further embodiment of the invention provides that the or each output member is disposed in an operative connection with a setting lever, whose one end is connected in an articulated manner with the related pivot lever being spaced apart at its end and whose free end interacts with the output member.

In principle, the setting lever can be attached to the output member in the previous embodiment. An advantageous further embodiment of the invention provides in this respect that the output member loosely impinges on the setting lever. In this way, an emergency disengagement, for example in the case of a power outage, is specifically facilitated.

A further embodiment of the embodiment with the setting lever provides that the output member presses against the free end of the setting lever to pivot an allocated supporting part from a starting position of the adjusting movement in the direction of an end position of the adjusting movement.

Another advantageous further embodiment of the invention provides that the pivot lever comprises a recess running in its longitudinal direction, being formed such that the output member and setting lever are incorporated into the recess in the starting position of the adjusting movement. This results in a more compact, flatter structure.

Another advantageous further embodiment of the invention provides that the pivot lever is formed as a two-armed lever, whose first lever arm impinges on the allocated, adjustable supporting part and whose second lever arm is disposed or able to be disposed in a drive connection with the output member of the drive device.

A further embodiment of the above embodiment provides that the output member is formed as a pressure piece, which presses against the second lever arm when adjusting the allocated supporting part.

A further embodiment of the embodiment of the two-armed lever provides that a strap is arranged between the second lever arm and the output member of the drive unit, whose first end disconnected from the pivoting axis of the pivot lever is connected in an articulated manner and around an axis being parallel to the pivoting axis with the second lever arm and whose second end is impinged on or can be impinged on by the output member. In this way, a particularly simple arrangement for the transmission of the driving force of the drive motor on the pivot lever is produced.

A further embodiment of the above embodiment provides that the output member loosely impinges on the second end of the strap using an engaging surface. In this way, an emergency disengagement of the furniture drive, for example in the case of a power outage, is facilitated.

To keep the strap engaged with the output member, an advantageous further embodiment provides that the engaging surface and the second end of the strap are profiled in cross-section and formed in a complementary manner to each other at least in sections.

With the aforementioned embodiment, it is advantageous if the engaging surface is concave in the cross-section and the second end of the strap is formed convexly, as is provided in a further embodiment.

Another further embodiment of the embodiment with the strap provides a spring to preload the second end of the strap against the engaging surface. In this way, the strap is kept securely engaged with the engaging surface.

An extraordinarily advantageous further embodiment of the embodiment with the strap provides that the strap is provided with a handle element, which is graspable through an opening in a casing of the dual drive such that the strap can be disengaged from the engaging surface contrary to the spring effect of the spring to disengage the dual drive. With this embodiment, an emergency disengagement of the dual drive is realized in a particularly simple way.

Another advantageous further embodiment of the invention provides that the output member is formed as a tension piece, which pulls on the second lever arm when adjusting the allocated supporting part. In this way, a particularly simple structure of the drive train is produced. Another advantage of this embodiment exists in that the threaded spindle is tensioned during the adjusting movement when using a spindle drive in the drive train. While the risk of a lateral removal of rivets exists with a pressure load of the spindle, this risk is avoided with a tensile load. Accordingly, the threaded spindle in this embodiment can have smaller dimensions than is the case with a pressure load, such that the manufacturing costs of the relevant dual drive are reduced.

An operative connection between the tension piece and the two-armed lever can be manufactured in any suitable way according to the relevant requirements. In this respect, an advantageous further embodiment provides that the tension piece is disposed in a drive connection with the two-armed lever by means of a boom with at least one rod or by means of a lever gear with at least one lever. Through the corresponding embodiment of the boom or the lever gear, an exemplary and specifically an additional gear reduction can be provided in the drive train.

A further embodiment of the aforementioned embodiment provides that the tension piece is connected by a rod with the second lever arm, wherein one end of the rod is connected in an articulated manner with the tension piece and the other end of the rod is connected to the pivoting axis of the two-armed lever spaced from the second lever arm in an articulated manner. In this way, a particularly simple structure is produced.

An electric motor adjustable support device to support a box spring mattress or an upholstered bed includes at least one dual drive according to the invention.

The invention is explained in more detail below referencing the attached schematic drawing, in which an embodiment of a furniture drive according to the invention and a support device according to the invention are represented. Thus, all features described in the description, represented in the drawing and claimed in the claims form in their own right and in any suitable combination with one another the subject of the invention, irrespective of their summary in the claims, and irrespective of their description or representation in the drawing. It is apparent to a person having ordinary skill in the art that the inventive features each form an embodiment in principle in their own right, i.e. irrespective of other features of this embodiment. Combinations of features of an embodiment with features of at least one other embodiment, i.e. feature combinations of the embodiments among each other, are also the subject of the invention.

Relative terms such as left, right, up, and down are for convenience only and are not intended to be limiting.

### BRIEF DESCRIPTION OF THE DRAWINGS

It can be seen that:

FIG. 1 shows a perspective view of an embodiment of an electric motor adjustable support device according to the invention for supporting a box spring mattress with a first embodiment, a furniture drive according to the invention in the form of a dual drive, wherein the support device is shown in the end position of the adjusting movement which corresponds to a maximally adjusted position,

FIG. 2 shows in the same representation as FIG. 1 the support device as per FIG. 1, wherein supporting parts of the support device are omitted,

FIG. 3 shows in the same representation as FIG. 2 the support device as per FIG. 2, wherein a frame of the support device is omitted,

FIG. 4 shows a detail from FIG. 3 in an enlarged scale compared to FIG. 3,

FIG. 5 shows in the same representation as FIG. 3 the support device as per FIG. 3, wherein the base unit being formed as a profile rail of the dual drive is omitted,

FIG. 6 shows a detail from FIG. 5 in an enlarged scale,

FIG. 7 shows a perspective view of a second embodiment of a dual drive according to the invention, wherein pivot levers of the dual drive are represented in a starting position of the adjusting movement,

FIG. 8 shows in the same representation as FIG. 7 the dual drive as per FIG. 7, wherein the pivot levers are represented in the end position of the adjusting movement,

FIG. 9 shows in the same representation as FIG. 8 the dual drive as per FIG. 8, wherein the half shell of a casing of the dual drive is omitted,

FIG. 10 shows a detail from FIG. 9 in the same representation as FIG. 9, but in an enlarged scale,

FIG. 11 shows in the same representation as FIG. 10 the dual drive as per FIG. 10, wherein a pressure piece of a drive unit of the dual drive is omitted for reasons of illustration,

FIG. 12 shows the pressure piece taken by itself in the same representation as FIG. 10,

FIG. 13 shows in the same representation as FIG. 9 the dual drive in the starting position of the adjusting movement represented in FIG. 7,

FIG. 14 shows a detail from FIG. 8 in the same representation as FIG. 8, but in an enlarged scale,

FIG. 15 shows in a perspective view a third embodiment of a dual drive according to the invention in a starting position of the adjusting movement in combination with an external frame of a support device,

FIG. 16 shows in the same representation as FIG. 15 the dual drive as per FIG. 15 in an end position of the adjusting movement,

FIG. 17 shows in a representation similar to FIG. 15 the dual drive without the support device,

FIG. 18 shows in a representation similar to FIG. 17 the dual drive as per FIG. 17, wherein parts of the dual drive are omitted for reasons of explanation and

FIG. 19 shows a detail from FIG. 18 in an enlarged scale compared to FIG. 18.

### DETAILED DESCRIPTION OF THE INVENTION

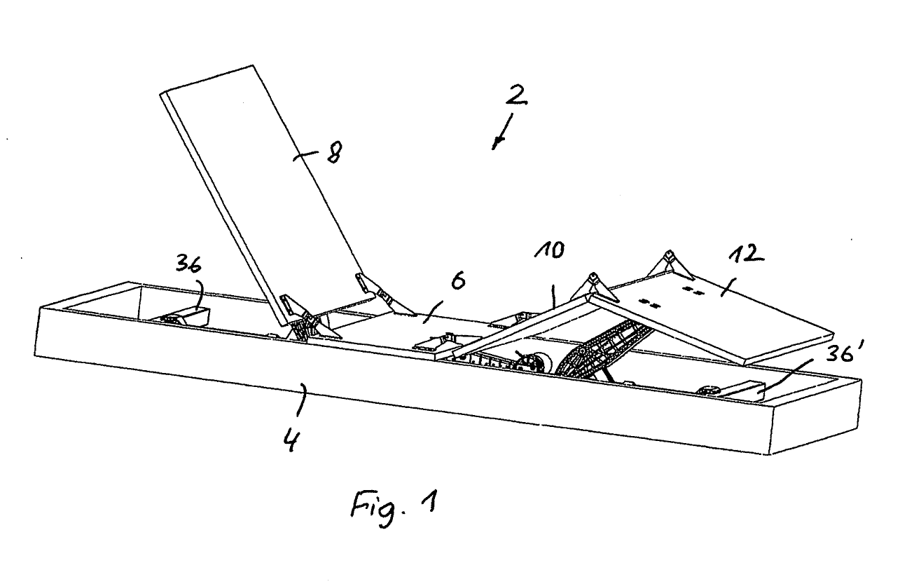

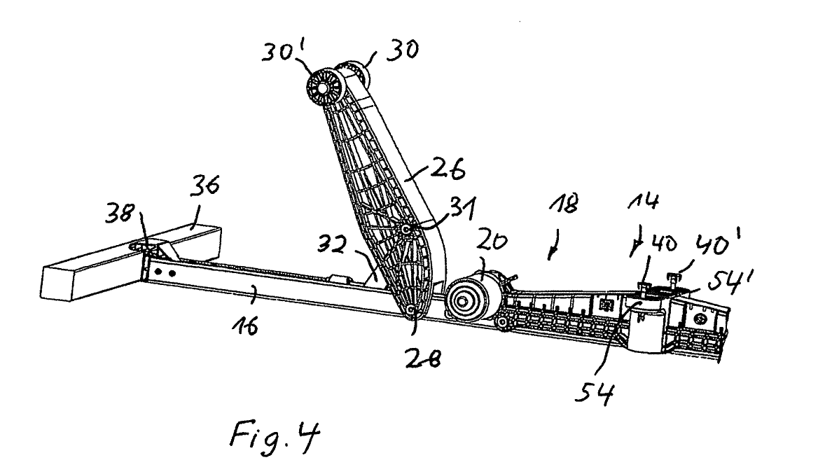

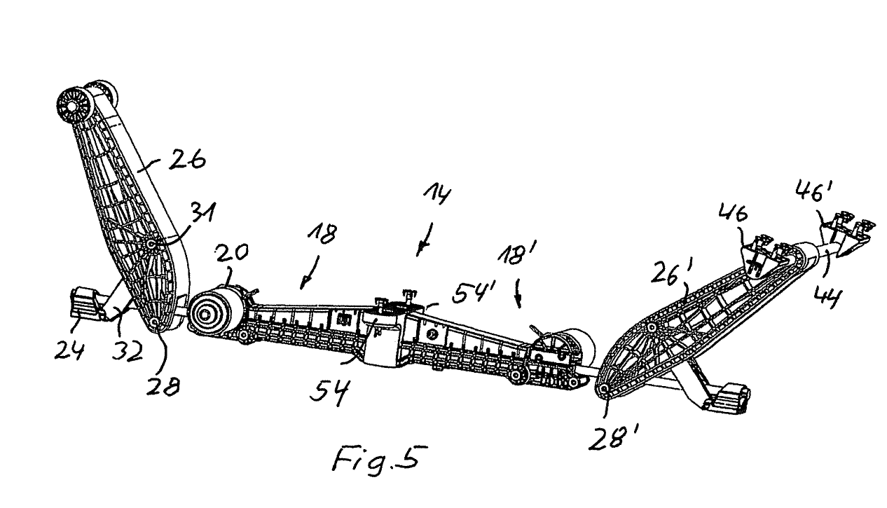

In order to explain a first embodiment of an electric motor adjustable support device according to the invention, which is provided with an embodiment of an electric motor dual drive, reference will be made to FIG. 1 to FIG. 6 below.

In FIG. 1, an embodiment of an electric motor adjustable support device 2 according to the invention to support a box spring mattress is represented. The box spring mattress itself is not shown to simplify the representation in the drawing.

The support device 2 comprises a frame 4 and plate-like supporting parts being pivotably adjustable to one another, which comprise a stationary central supporting part 6, with which one end is connected in an articulated manner and pivotable around a horizontal pivoting axis to an upper body supporting part 8. With the end of the central supporting part 6 facing away from the upper body supporting part 8 is connected in an articulated manner and pivotable around a horizontal pivoting axis a leg supporting part 10, on which a calf supporting part 12 is hinged.

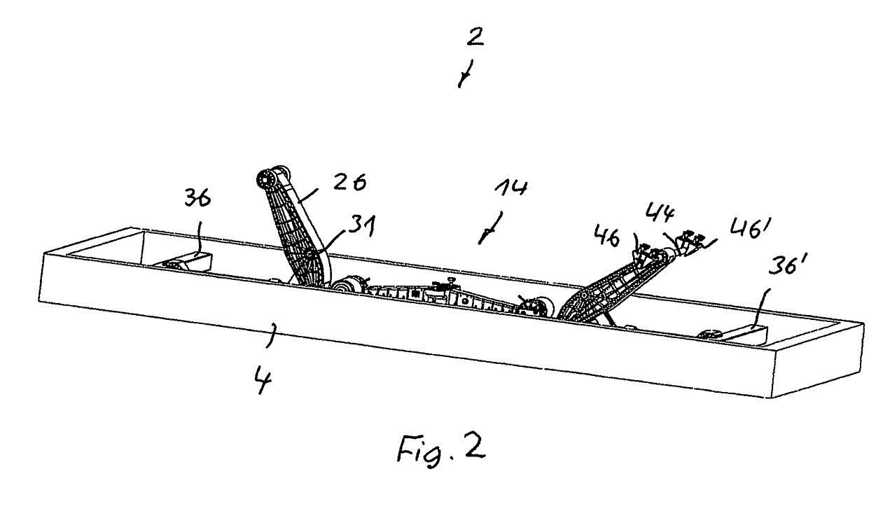

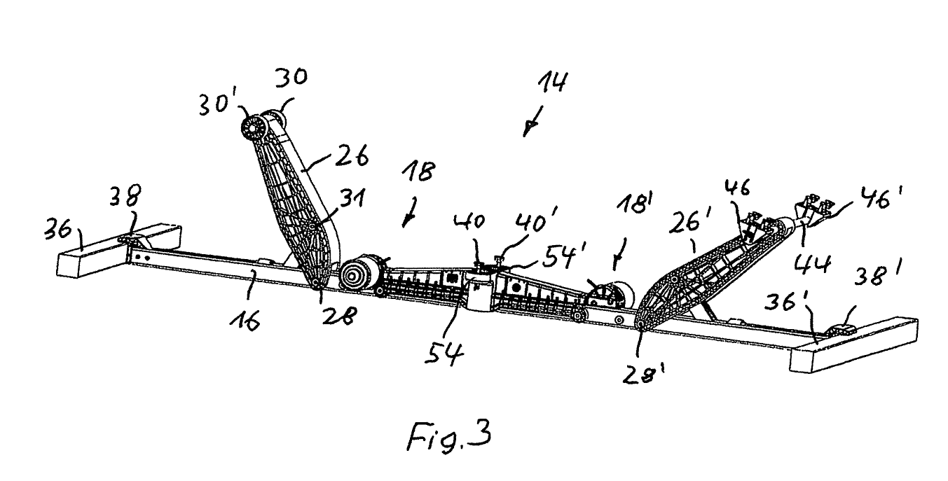

In FIG. 2, the supporting parts 6 to 12 are omitted to simplify the representation. In FIG. 3, the frame 4 of the support device 2 is also omitted.

The structure of an embodiment of a dual drive 14 according to the invention is explained below. The dual drive 14 comprises a base unit 16, which is formed as a C profile rail in this embodiment. Two drive units 18, 18′ are arranged on the base unit 16, wherein the drive unit 18 is allocated to the upper body supporting part 8 to adjust the same and the drive unit 18′ is allocated to the leg supporting part 10 and the calf supporting part 12 to adjust the same. Only the drive unit 18 will be explained in more detail below. The drive unit 18′ is constructed in the same manner and is therefore not further explained here.

The drive unit 18 comprises an electric motor 20, which is disposed in a rotary drive connection by means of a worm gear with a threaded spindle 22, on which non-rotatably and moving linearly in the axial direction of the threaded spindle 22 a spindle nut 24 is arranged, which forms the output member of the drive unit 18. To pivot the upper body supporting part 8 relative to the central supporting part 6, a pivot element in the form of a pivot lever 26 is provided, which is pivot-mounted to the base unit 16 of the dual drive 14 around a pivoting axis 28. The end of the pivot lever 26 facing away from the pivoting axis 28 bears rollers 30, 30′, on which the upper body supporting part 8 is supported with its side facing away from the box spring mattress, such that the pivot lever 26 loosely impinges on the upper body supporting part 8.

With the pivot lever 26, in an articulated manner at an interval to its end, one end of the setting lever 32 is connected, the other end of which is loosely impinged on by the spindle nut 24.

Based on a starting position of the adjusting movement, in which the upper body supporting part 8 spans a fundamentally horizontal support plane together with the central supporting part 6 and the leg supporting part 10 as well as the calf supporting part 12, the electric motor 20 actuates the threaded spindle 22 such that the spindle nut 24 in the drawing moves towards the right and presses against the facing end of the setting lever 32, whereby the setting lever 32 is positioned. Thus, the pivot lever 26 in the drawing is pivoted in a clockwise direction such that the upper body supporting part is pivoted in the desired manner.

The resetting from the end position of the adjusting movement being represented in the drawing into the starting position is carried out with an activated electric motor 20, but under the weight force of the upper body supporting part 8 or a person reposing on the support device 2.

The pivot levers 26, 26′ are formed by injection molded parts made of plastic in the represented embodiment.

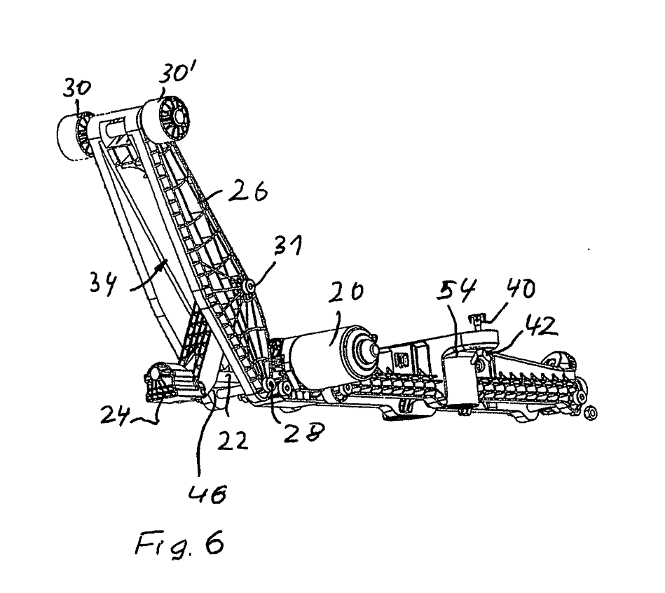

As is visible in FIG. 6, the pivot lever 26 comprises on its side facing the spindle nut 24 and setting lever 32 a recess 34 running in the longitudinal direction of the pivot lever 26, which is such formed that in the starting position of the adjusting movement, in which the upper body supporting part 8 is significantly arranged horizontally, the spindle nut 24 and the setting lever 32 are incorporated into the recess 34.

As a result of the pivot lever 26 being attached pivot-mounted to the base unit 16 of the dual drive 14, a separate adjustment fitting becomes superfluous. In this way, a particularly simple structure is produced. In contrast to known dual drives, with which the link lever is disposed into an operative connection with the allocated output member during the assembly of the dual drive, the pivot lever 26, 26′ is permanently attached to the base unit for the dual drive 14 according to the invention, such that the dual drive 14 and the pivot lever 26, 26′ form one unit.

As to the invention, the dual drive 14 is formed for toolless installation on the support device 2. With the represented embodiment, the support device 2 comprises struts 36, 36′ running transversely to its longitudinal direction (see specifically FIG. 2 and FIG. 3). At the end of the profile rail, which forms the base unit 16 of the dual drive 14, cushioning elements 38, 38′ are arranged, with which the base unit 16 is supported on the struts 36, 36′ in the installation position represented in the drawing of the dual drive 14. According to the relevant requirements, the cushioning elements 38, 38′ can be attached to the struts 36, 36′ using a suitable fastener. However, in the represented embodiment, the cushioning elements 38, 38′ are laid loosely on the struts 36, 36′. The interval between vertical surfaces of the cushioning elements 38, 38′ facing away from one another corresponds substantially to the clear span between the cross struts 36, 36′. If necessary, the dual drive 14 can be lightly clamped between the cross struts 36, 36′.

With the represented embodiment, a further fastener is provided for the toolless fastening of the central supporting part 6 to the base unit 16 of the dual drive 14, which comprise a toolless, hand-operated screwing device in this embodiment. In the represented embodiment, the screwing device comprises threaded bolts 40, 40′ (see FIG. 3), using which the central supporting part 6 is screwed to the base unit 16 of the dual drive 14. In the sense of toolless attachment, winged screws are provided for this purpose, of which only one winged screw 42 is visible in FIG. 6.

To disassemble the dual drive 14, for example for maintenance purposes, it is only necessary to loosen the threaded bolts 40, 40′ and to lift the cushioning elements 38, 38′ from the struts 36, 36′. The assembly and disassembly of the dual drive 14 are thereby completely toolless and particularly easy to achieve.

The pivot lever 26′ being allocated to the leg supporting part 10 and the calf supporting part 12 bears at its ends an axis 44 (see FIG. 3) running parallel to the pivoting axis of the pivot lever 26′, the axis being incorporated in the installation position of the dual drive 14 into receptacles 46, 46′, which are attached to the underside of the calf supporting part 12. In this way, the leg supporting part 10 and the calf supporting part 14 are adjusted when pivoting the pivot lever 26.

A method for the emergency lowering of a supporting part being adjusted by a dual drive according to the invention also has independent inventive significance. If for example the electricity cuts out in the adjusting position being shown represented in FIG. 6 of the pivot lever 26 and thereby of the upper body supporting part 8, the pivot lever 26 can be moved manually in a clockwise direction in FIG. 6 such that the setting lever 32 is disengaged from the spindle nut 24 and the pivot lever 26 is thereby decoupled from the traction train of the drive unit 18. Subsequently, the pivot lever 26 in the drawing can be moved in a counter-clockwise direction, wherein the upper body supporting part moves back into the starting position and the setting lever 32 glides to the left through the spindle nut 24 in the drawing. In the starting position of the adjusting movement being re-achieved at the end of this movement, the setting lever 32 and the spindle nut 24 are incorporated into the recess 34 of the pivot lever 26.

To move the pivot lever 26 back into the drive connection with the traction train of the drive unit 18, it is only necessary to control the electric motor 20 such that the spindle nut 24 in the drawing moves back into its starting position towards the left. It thereby underpins the setting lever 32 such that this moves over the spindle nut 24 and reengages with the end of the spindle nut 24 facing towards the electric motor 20 thereby re-establishing the drive connection. To make this procedure easier, the setting lever 32 can be fitted on the underside of its free end with a run-in slope 46 as shown in FIG. 6. The emergency lowering is thereby particularly easily designed.

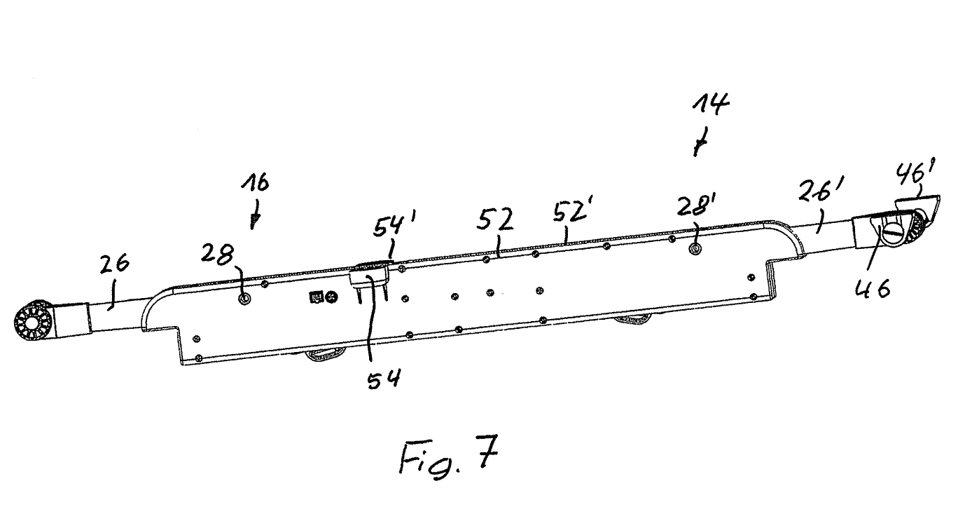

To explain a second embodiment of a dual drive according to the invention, reference is made to FIGS. 7 to 14 below.

In FIG. 7, a second embodiment of a dual drive 14 according to the invention is represented, at the base unit 16 of which in conformity with the first embodiment pivot elements are each pivot-mounted in the form of pivot levers 26, 26 around a pivoting axis 28, 28′. In further conformity with the first embodiment, the dual drive 14 is formed for toolless installation on a support device for a box spring mattress or upholstered bed, as was explained for the first embodiment. FIG. 7 shows the dual drive 14 in a starting position of the adjusting movement with a position of the pivot levers 26, 26 conforming to an adjusting position of the support device, in which the supporting parts span a substantially horizontal support plane.

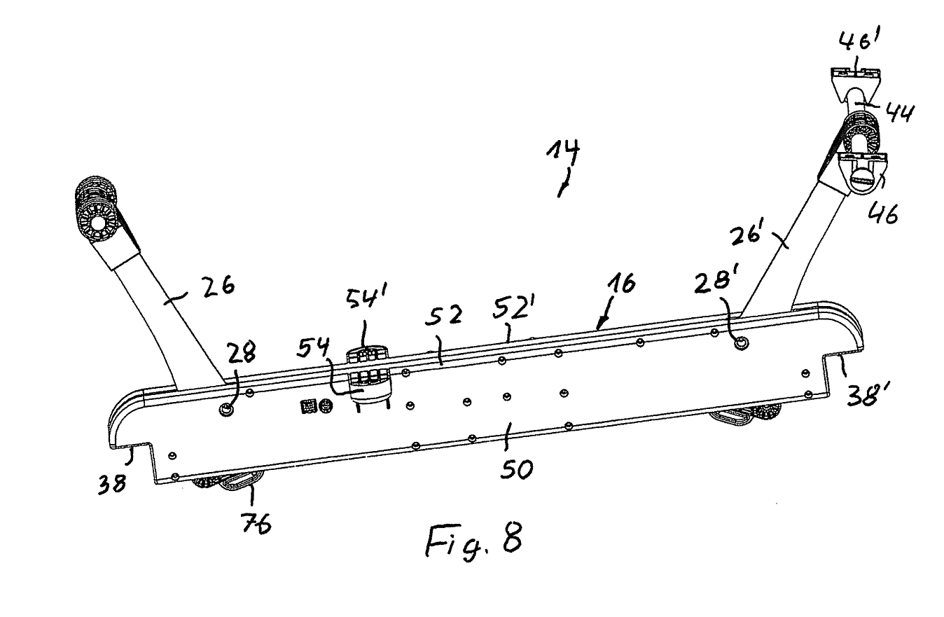

FIG. 8 shows the dual drive as per FIG. 7 in a position of the pivot lever 26, 26′ corresponding to an end position of the adjusting movement, in which the supporting parts are maximally adjusted relative to each other.

The second embodiment differs initially from the first embodiment thus that the base unit 16 is formed as a casing 50, into which the drive units being allocated to the pivot levers 26, 26′ are incorporated. The casing 50 consists in the represented embodiment of two half shells 52, 52′ made of plastic. The half shells 52, 52′ are connected with screws to one another or can be connected with screws to one another.

On the ends of the casing 50 being located in the longitudinal direction, cushioning elements 38, 38′ are formed in the casing, with which the dual drive 14 is positioned in the installation position on transversal struts of a support device and is supported on these (see the reference numeral 36, 36′ in FIG. 3).

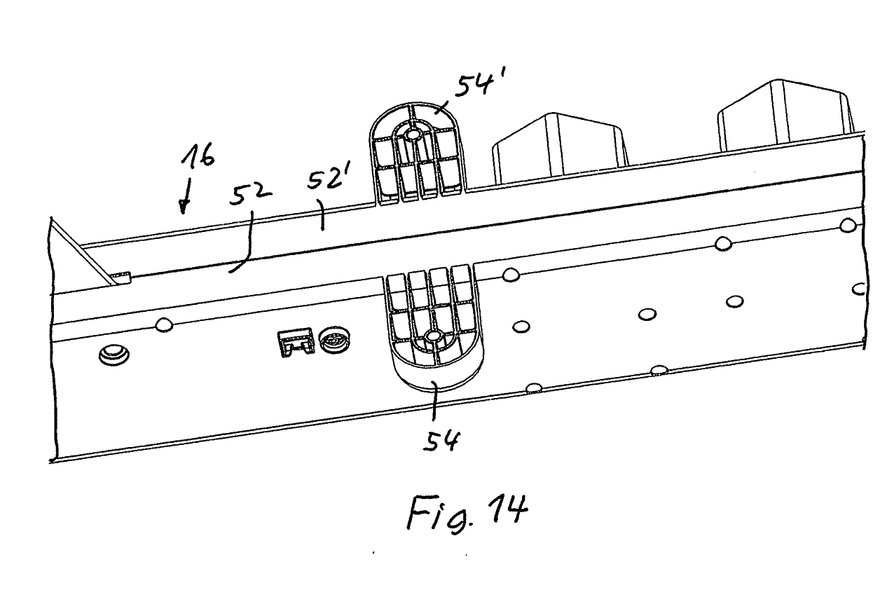

For attachment to a fixed central supporting part of a support device, fastening straps 54, 54′ are fitted on the half shell 52, 52′, as shown in FIG. 8 and particularly well in FIG. 14.

The installation of the dual drive 14 on a support device is principally executed in the same way as is explained in the first embodiment. For this purpose, the dual drive 14 is positioned on the transversal struts of the support device by means of cushioning element 38, 38′. Subsequently, the dual drive 14 can be screwed by means of the fastening straps 54, 54′ with its casing to a fixed central supporting part of a support device. The screwing can specifically be produced using a toollessly operable screwing device.

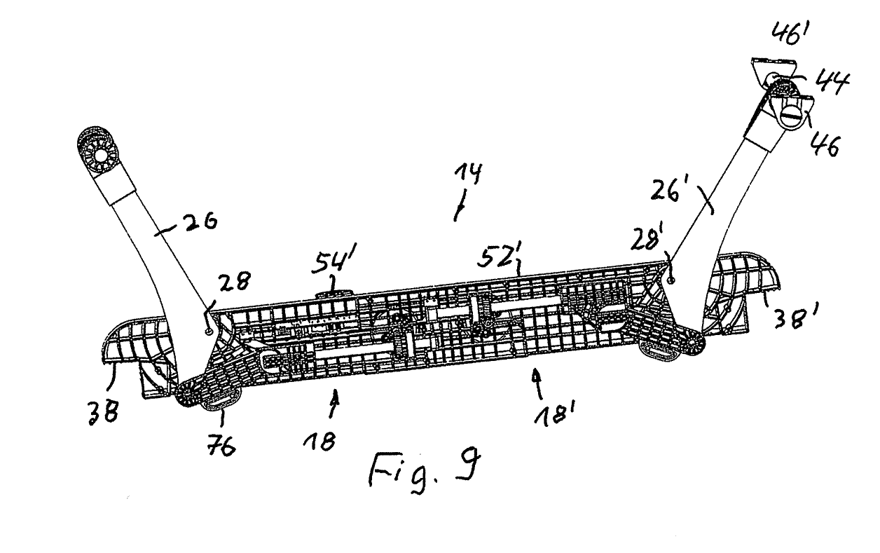

On the basis of FIGS. 9 to 12, the drive units 18, 18′ of the dual drive 14 are explained in detail below.

FIG. 9 shows the dual drive 14 in the adjusting position according to FIG. 1, wherein for reasons of explanation of the structure of the drive units 18, 18′ the half shell 52 of the casing 16 is omitted. Only the drive unit 18 will be explained in more detail below, the drive unit 18′ is constructed in the same manner and is therefore not further explained.

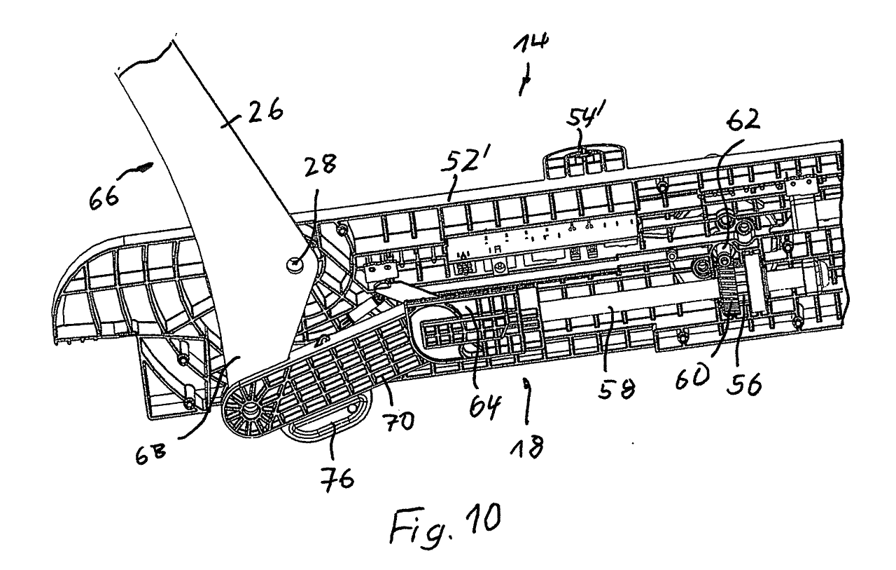

The drive unit 18 comprises a fixed spindle nut 56 being rotatably mounted in the casing 16, the spindle nut being attached to a threaded spindle 58 being non-rotatably mounted in the casing 16 and moveable in its axial direction. With the spindle nut 56 a screw wheel 60 is non-rotatably connected, which is engaged with a worm 62, which is engaged with a driveshaft of an electric motor of the drive unit 18 such that the threaded spindle 58 moves left or right according to the rotational direction of the driveshaft of the electric motor in FIG. 10.

For the power supply and control of the drive units 18, 18′, power supply and a control not represented in the drawing are provided, whose basic structure is however generally known to the person skilled in the art and is therefore not explained in detail here.

A pressure piece 64 is fitted to the end of the threaded spindle 58 facing the pivoting axis 28.

Departing from the first embodiment, the pivot lever 26 of the second embodiment is embodied as a two-armed lever, whose first lever arm 66 loosely impinges on the allocated adjustable supporting part and whose second lever arm 68 is disposed in a drive connection with the drive element being formed by the pressure piece 64 of the drive unit 18.

A strap 70 is arranged between the second lever arm 68 and the pressure piece 64 of the drive unit 18, whose first end disconnected from the pivoting axis 28 is connected in an articulated manner with the second lever arm 68 and whose second end can be pressurized by the pressure piece 64 or is pressurized during the adjusting movement. In the represented embodiment, the pressure piece applies the second end of the strap 70 loosely using an engaging surface.

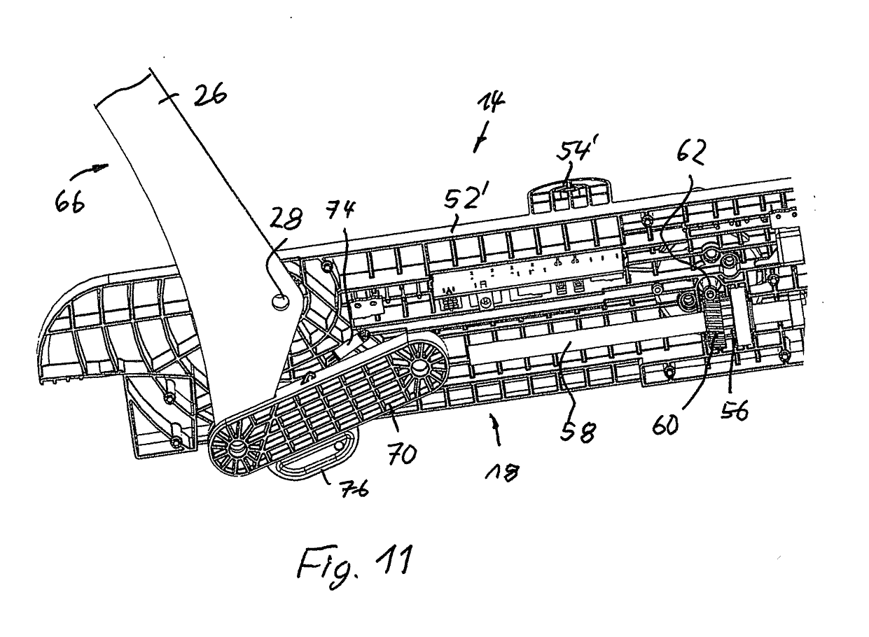

FIG. 11 shows the drive unit 18, wherein the pressure piece 64 is omitted for reasons of explanation.

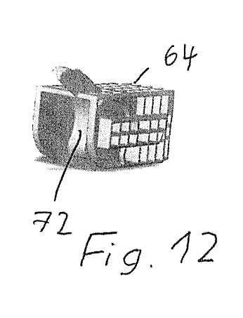

FIG. 12 shows the pressure piece 64 in itself, wherein an engaging surface 72 of the pressure piece 64 is specifically visible.

From FIG. 11 and FIG. 12 as well as a comparison of FIG. 11 with FIG. 12, it is visible that the engaging surface 72 and the second end of the strap are profiled in the cross-section and formed in a complementary manner to each other. In the represented embodiment, the engaging surface 64 is formed concavely in the cross-section and the second end of the strap is formed convexly in a correspondingly complementary manner, wherein the engaging surface 72 and the end of the strap 70 are embodied in an arch shape in the cross-section.

To preload the second end of the strap 70 against the engaging surface 72 of the pressure piece 64, a spring is provided, which is formed in this embodiment between an internal wall of the casing 50 and the control spring acting as the strap 70 in the form of a compression spring 74.

To adjust the pivot lever 26 and thereby the allocated supporting part from the starting position represented in FIG. 7 of the adjusting movement in the direction of the end position represented in FIG. 8 of the adjusting movement, the electric motor drives the spindle nut 56 such that the threaded spindle 58 moves towards the left with the pressure piece 64 in FIG. 10. Hereby, the pressure piece 64 presses against the second end of the strap 70. Using the compression spring 74, the second end of the strap 70 is thereby held in engagement with the engaging surface 72. During the movement of the pressure piece 64 in FIG. 10 towards the left, the pivot lever 26 in FIG. 10 pivots in a clockwise direction such that the supporting part impinged upon by the pivot lever 26 is pivoted in the desired manner.

If the electricity goes off in the adjusted support device, the pivot lever 26 can be manually reset as follows with the thereby adjusted supporting part in the sense of an emergency lowering:

To execute an emergency lowering, the pivot lever 26 is manually moved in the clockwise direction beyond the end position represented in FIG. 10 of the adjusting movement in FIG. 10, wherein the second end of the strap 70 is disengaged from the engaging surface 72 of the pressure piece 64. The strap 70 is hereby drawn upwards by the compression spring 74.

The strap 70 is provided with a handle element 76 on its lower end, which is accessible through an opening formed in the casing 50, as can be seen in FIG. 8. Using the handle element 76, the strap 70 can be drawn downwards and moved out of the trajectory of the pressure piece 64. Subsequently, the pivot lever with the thereby adjusted supporting part in FIG. 10 can be reset in the anticlockwise direction, wherein the strap 70 moves outside of the casing 50 under the shutdown pressure piece.

To reengage the strap 70 with the engaging surface 72 and to thereby reactivate the drive unit 18, the pivot lever 26 can be manually moved in the clockwise direction in FIG. 10, wherein the strap 70 is reengaged with the engaging surface 72 of the pressure piece 64 under the effect of the compression spring 74.

An emergency lowering is realized in this way, which has an independent inventive significance in itself.

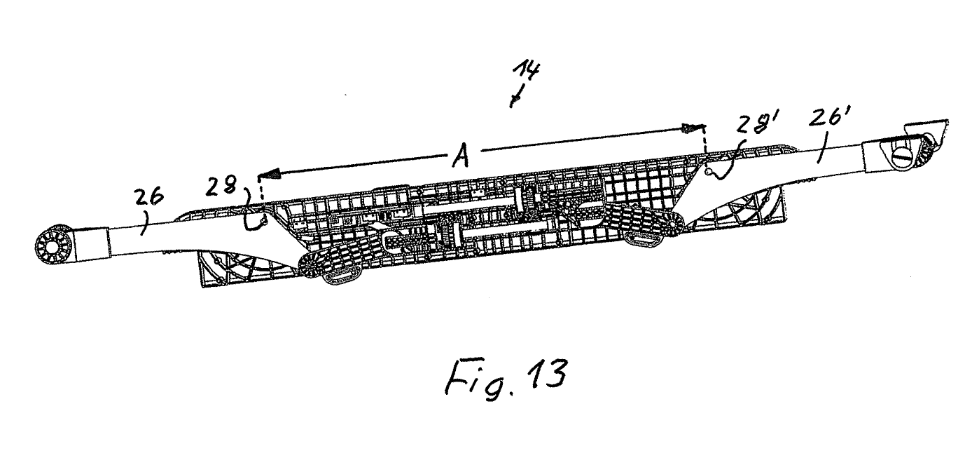

In FIG. 13, the interval between the pivoting axes 28, 28′ is labelled with “A”. According to an embodiment of the invention, which has an independent inventive significance in itself for dual drives of any kind, the interval “A” is greater than 620 mm. Particularly favorable conditions arise in this way when adjusting supporting parts of a support device.

A variation of the aforementioned embodiment exists in that the base unit is arranged on a support element, specifically made of metal, which comprises at its ends cushioning elements or cushioning areas for cushioning on cross struts of an external frame existing specifically of metal of a support device for supporting a box spring mattress or upholstered bed, wherein the support element on the cross struts span resting on the external frame in its longitudinal extension. This embodiment has an independent inventive significance. The support element can thereby be formed specifically by a flat iron. In this embodiment, the installation of a dual drive according to the invention takes place such that the support element is disposed with its ends on the cross struts of the external frame. If necessary, the support element can then be attached to the external frame. For the rest, the functional principle is the same as the previous embodiments.

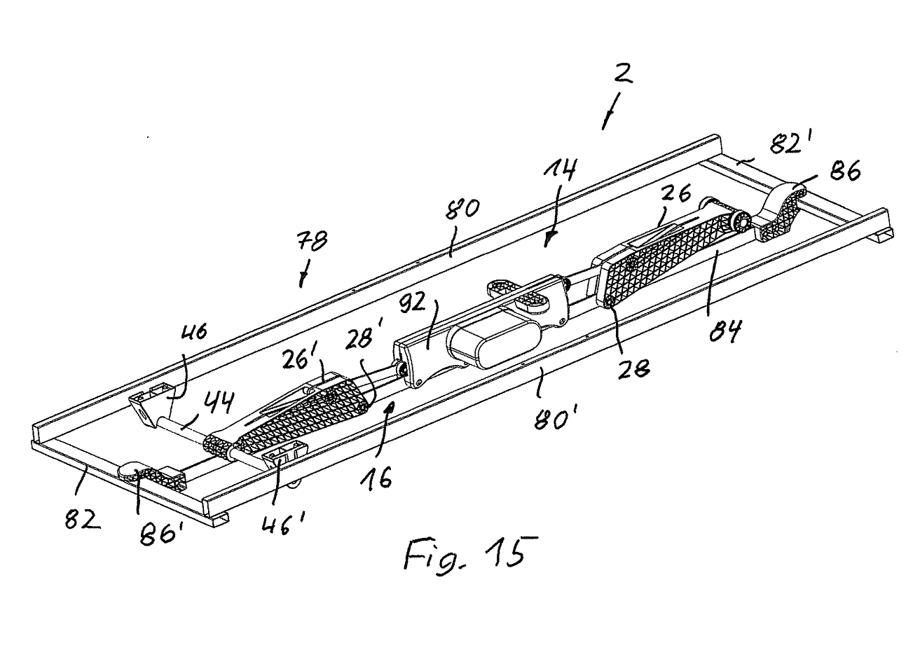

A third embodiment of a furniture drive according to the invention in the form of a dual drive 14 is explained below referencing FIGS. 15 to 19.

FIG. 15 shows the dual drive 14 in combination with a support device 2, of which only an external frame 78 is represented for reasons of representation, which comprises longitudinal struts 80, 80′ running in the longitudinal direction, which are connected at their ends with one another using cross struts 82, 82′. The supporting parts of the support device 2 are not shown in FIGS. 15 to 19 for reasons of representation.

FIG. 15 shows the dual drive 14 in a starting position of the adjusting movement, in which the supporting parts span together a substantially horizontal support plane.

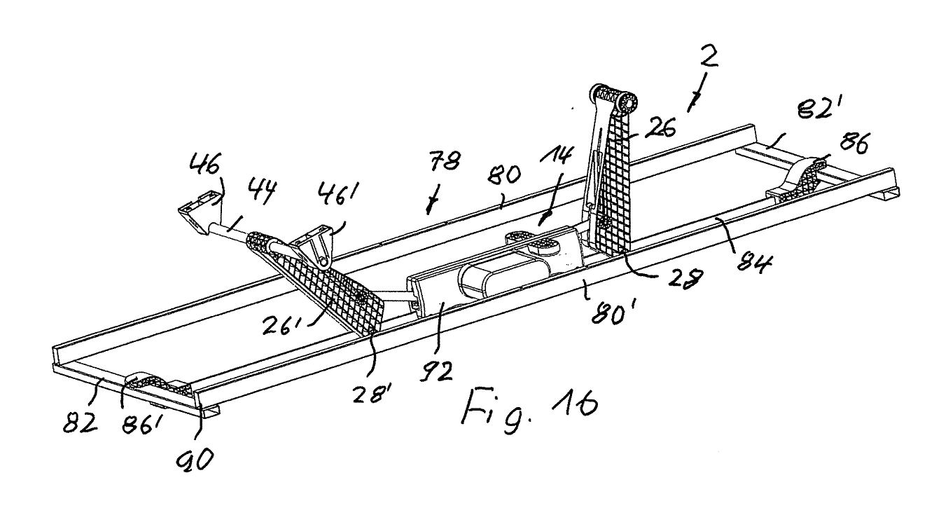

FIG. 16 shows the dual drive 14 in an end position of the adjusting movement, in which the supporting parts are maximally pivot-adjusted relative to one another.

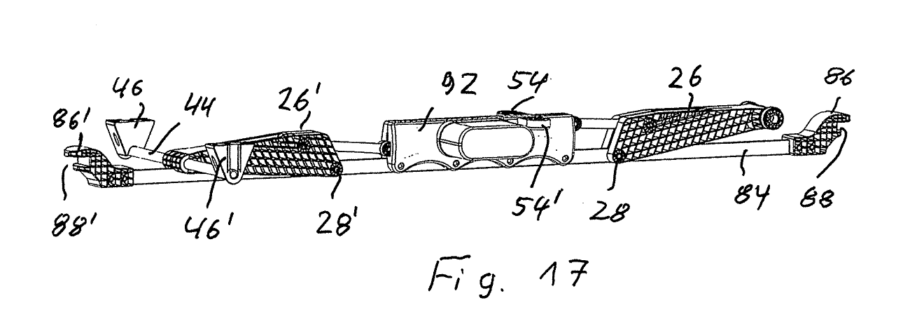

FIG. 17 shows the dual drive 14 in itself, i.e. without the support device 2. In the represented embodiment, the base unit 16 of the dual drive 14 comprises a support element 84, which is formed in this embodiment by a flat iron. At its ends, the support element 84 comprises cushioning elements 86, 86′, which are formed by separate plastic components being connected with the support element 84 and each comprise a mouth-shaped opening 88 or 88′ facing away from each other. The clear span of the mouth-shaped opening 88 or 88′ corresponds substantially to the height of the longitudinal struts 80, 80′.

To assemble the dual drive 14 on the external frame 84, the dual drive 14 is used such in the opening being limited by the external frame 78 that its longitudinal axis coincides substantially with a connecting line between corner points 90, 90′ of the external frame 78 (see FIG. 16). Starting from this position, the dual drive 14 is then turned into the installation position represented in FIG. 16, in which the mouth-shaped openings 88 or 88′ of the cushioning elements 86 or 86′ encompass the cross struts 82 or 82′ in a slightly clamping way, such that the dual drive 14 is connected with the frame. The mouth-shaped openings 88, 88′ are thereby dimensioned such that the dual drive 14 is arranged in the installation position tension-free between the longitudinal struts 80, 80′.

As is specifically visible from FIG. 17, the dual drive 14 comprises a casing-like central part 92 being connected somewhat centrally with the support element 84, which is formed in the represented embodiment by two half shells made of plastic. The drive units 18, 18′ of the dual drive 14 are incorporated into the casing-like central part 92.

As is specifically visible from FIG. 17, the pivot lever 26, 26′ is attached pivot-mounted to the base unit 16 in concordance with the two first embodiments. With the represented embodiment, the pivoting axes 28, 28′ are hereto attached pivot-mounted to the support element 84.

The fastening straps 54, 54′ are fitted on the half shells of the casing-like central part 92.

To attach the dual drive 16 to the supporting parts, it is only necessary in the installation position being represented in FIG. 15 of the dual drive that the fixed central supporting part 6, to which the upper body supporting part 8 and the leg supporting part 10 are articulated with the calf supporting part 12 is screwed to the central part 92 of the dual drive 14 using the fastening straps 54, 54′. For this, a toollessly operable screwing device can be specifically used, as this was explained on the basis of the two first embodiments. The installation of the dual drive 14 to the support device 2 then takes place completely toollessly and thereby in a particularly simple and quick manner. In this connection, the pivot lever 26 impinges loosely on the upper body supporting part 8. The receptacles 46, 46′ for the axis 44 can be preinstalled on the calf supporting part 12 such that it is only necessary that the axis 54 is pressed into the relevant openings of the receptacles 46, 46′. This installation step also thereby occurs toollessly.

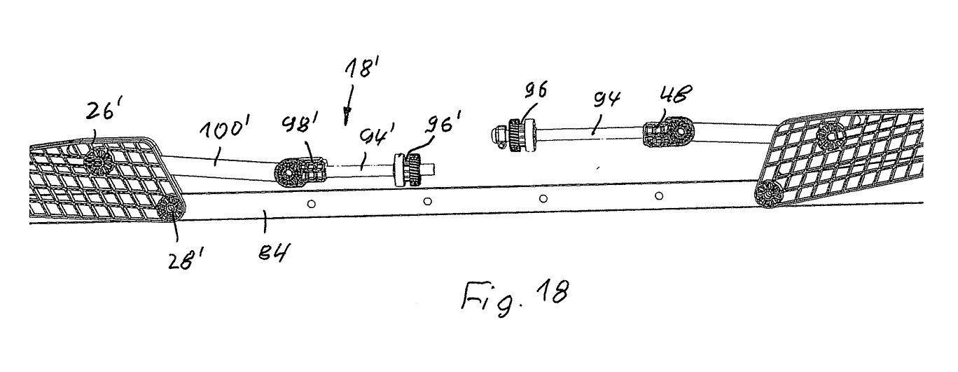

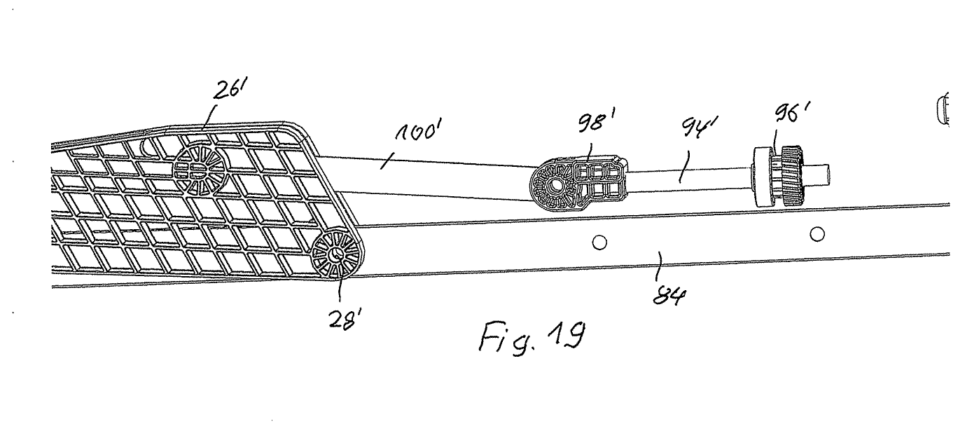

Referencing FIGS. 18 and 19, the structure of the drive units 18, 18′ of the dual drive 16 are explained in detail below. Only the drive unit 18′ will be thereby explained in more detail. The drive unit 18 is constructed in the same manner.

For reasons of explanation, the half shells of the central part 92 and other components of the drive units 18, 18′ are omitted in FIGS. 18 and 19.

Deviating from the previous embodiments, in the third embodiment, the output member of the drive unit 18′ is formed by a threaded spindle 94′, which is mounted in the central part 92 non-rotatably and moveably in the axial direction. On the threaded spindle 94′, a fixed spindle nut 96 is arranged, which is disposed in a rotary drive connection with the drive motor of the drive unit 18′.

With the end facing away from the spindle nut 96′ of the threaded spindle 94, a tension piece 98′ is connected, which is disposed in an operative connection to the pivot lever 26′ via a boom, which comprises in this embodiment an individual rod 100′.

As specifically visible in FIG. 19, one end of the rod 100′ around a joint axis being parallel to the pivoting axis 26′ is connected in an articulated manner with the tension piece 98′, while the other end of the rod 100 eccentrically to the pivoting axis 26′ around a joint axis being parallel to the pivoting axis 28′ is connected in an articulated manner with the pivot lever 26′.

To execute an adjusting movement, the electric motor drives the spindle nut 96′ such that the threaded spindle 94′ moves towards the right in FIG. 19. Hereby the tension piece 98′ pulls eccentrically to the pivoting axis 28′ on the pivot lever 26′ such that this pivots around the pivoting axis 28′, wherein the leg supporting part 10 is pivot-mounted together with the upper body supporting part 12 in the desired manner. The threaded spindle 94′ is thereby tensioned.

As is visible in FIG. 18, the threaded spindles 94′, 94 are parallel in the central part 92 of the dual drive 16, but arranged staggered together vertically to their longitudinal axes along the height extension of the central part 92. In this way, the free end facing away from the spindle nut 96′ of the threaded spindle 94′ moves into the space below the spindle nut 96 and the threaded spindle 94 during the adjusting movement, while the free end facing away from the tension piece 98 of the threaded spindle 94 moves into the space above the spindle nut 96′ and the threaded spindle 94′ during the adjusting movement. In this way, a particularly compact structure of the dual drive 14 is produced such that the casing-like central part 92 of the dual drive 14 can be correspondingly small in dimension.

The third embodiment of the dual drive 14 according to the invention is particularly simple and compact in structure.

Due to the pivot lever 26, 26′ being attached pivot-mounted according to the invention on the base unit 16 of the dual drive 14, the pivot lever 26, 26′ are permanently connected with the base unit 16 of the dual drive 14 and form with this a jointly manageable unit, which can be mounted or attached to the supporting parts of the relevant support device in a simple manner for installation of the dual drive 14.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

What is claimed is:

1. Electric motor dual drive for adjusting supporting parts pivot-mounted relative to one another of a support device to support a box spring mattress or upholstered bed, comprising:
a) a base, on which two drive units are arranged, which each includes an output member interacting with a pivot lever in the installation position of the dual drive, which is disposed in an operative connection with an adjustable supporting part to pivot the same; and
b) each of the pivot levers being attached pivot-mounted to the base, such that the base, together with the pivot levers, forms a unit attachable to a support device.

2. The electric motor dual drive according to claim 1, wherein:
a) each of the output member is linearly movable.

3. The electric motor dual drive according to claim 2, wherein:
a) each of the output members is a spindle nut, which is arranged non-rotatably and moveable in the axial direction on a fixed threaded spindle, disposed in a rotary drive connection with an electric motor of the drive unit.

4. The electric motor dual drive according to claim 2, wherein:
a) each of the output members is a spindle nut, which is mounted non-rotatably and moveable in the axial direction, and on which a fixed threaded spindle is arranged, which is disposed in a rotary drive connection with an electric motor of the drive unit.

5. The electric motor dual drive according to claim 1, wherein:
a) each of the output members is disposed in an operative connection with a setting lever, whose one end is connected in an articulated manner with the respective pivot lever being spaced apart at its end, and whose other free end interacts with the output member.

6. The electric motor dual drive according to claim 5, wherein:
a) the output member impinges loosely on the setting lever.

7. The electric motor dual drive according to claim 5, wherein:
a) the output member presses against the free end of the setting lever to pivot an allocated supporting part from a starting position of the adjusting movement in the direction of an end position of the adjusting movement.

8. The electric motor dual drive according to claim 7, wherein:
a) a pivot lever includes a recess running in its longitudinal direction, formed such that the output member and setting lever are incorporated into the recess in the starting position of the adjusting movement.

9. The electric motor dual drive according to claim 1, wherein:
a) at least one of the pivot levers is formed as a two-armed lever, whose first lever arm loosely impinges on the allocated adjustable supporting part and whose second lever arm is disposed or disposable in a drive connection with the drive element of the drive unit.

10. The electric motor dual drive according to claim 9, wherein:
a) the output member is formed as a pressure piece, which presses against the second lever arm when adjusting the allocated supporting part.

11. The electric motor dual drive according to claim 9, wherein:
a) a strap is arranged between the second lever arm and the output member of the drive unit, whose first end disconnected from the pivoting axis of the pivot lever is connected in an articulated manner and around an axis being parallel to the pivoting axis with the second lever arm and whose second end is impinged on or can be impinged on by the output member.

12. The electric motor dual drive according to claim 11, wherein:
a) the output member loosely impinges on the second end of the strap using an engaging surface.

13. The electric motor dual drive according to claim 12, wherein:
a) the engaging surface and the second end of the strap are profiled in cross-section and formed in a complementary manner to each other at least in sections.

14. The electric motor dual drive according to claim 13, wherein:
a) the engaging surface is formed concavely in the cross-section and the second end of the strap is formed convexly.

15. A dual drive according to claim 12, wherein:
a) a spring is provided to pretension the second end of the strap against the engaging surface.

16. The electric motor dual drive according to claim 14, wherein:
a) the strap is provided with a handle element, which is graspable through an opening in a casing of the dual drive such that the strap can be disengaged from the engaging surface contrary to the spring effect of the spring.

17. The electric motor dual drive according to claim 9, wherein:
a) the output member is formed as a tension piece, which pulls the pivot lever when adjusting the allocated supporting part.

18. The electric motor dual drive according to claim 17, wherein:
a) the tension piece is disposed in a drive connection with the pivot lever using a boom with at least one rod or using a lever gear with at least one lever.

19. The electric motor dual drive according to claim 18, wherein:
a) the tension piece is connected with the pivot lever via a rod, and the one end of the rod is connected in an articulated manner with the tension piece, and the other end of the rod to the pivoting axis of the pivot lever is connected eccentrically in an articulated manner with the pivot lever.

20. An electric motor adjustable support device to support a box spring mattress or an upholstered bed which includes the electric motor dual drive according to claim 1.
